(19) United States
(12) Patent Application Publication
(10) Pub. No.: US 2009/0222272 A1
(43) Pub. Date: Sep. 3, 2009

(54) Controlling Spatial Audio Coding Parameters as a Function of Auditory Events

(75) Inventors: Alan Jeffrey Seefeldt, San Francisco, CA (US); Mark Stuart Vinton, San Francisco, CA (US)

Correspondence Address: Dolby Laboratories Inc., 999 Brannan Street, San Francisco, CA, 94103, US

(73) Assignee: Dolby Laboratories Licensing Corporation, San Francisco, CA (US)

(21) Appl. No.: 11/989,974

(22) PCT Filed: Jul. 24, 2006
(86) PCT No.: PCT/US2006/028874

§ 371 Date: Feb. 1, 2008

Related U.S. Application Data
(60) Provisional application No. 60/705,079, filed on Aug. 2, 2005.

(51) Int. Cl. G10L 21/00

(52) U.S. Cl. 704/500; 704/E21.001

(57) ABSTRACT

An audio encoder or encoding method receives a plurality of input channels and generates one or more audio output channels and one or more parameters describing desired spatial relationships among a plurality of audio channels that may be derived from the one or more audio output channels, by detecting changes in signal characteristics with respect to lime in one or more of the plurality of audio input channels, identifying as auditory event boundaries changes in signal characteristics with respect to lime in the one or more of the plurality of audio input channels, an audio segment between consecutive boundaries constituting an auditory event in the channel or channels, and generating all or some of the one or more parameters al least partly in response to auditory events and/or the degree of change in signal characteristics associated with the auditory event boundaries. An auditory-event-responsive audio upmixer or upmixing method is also disclosed.

### TECHNICAL FIELD

The present invention relates to audio encoding methods and apparatus in which an encoder downmixes a plurality of audio channels to a lesser number of audio channels and one or more parameters describing desired spatial relationships among said audio channels, and all or some of the parameters are generated as a function of auditory events. The invention also relates to audio methods and apparatus in which a plurality of audio channels are upmixed to a larger number of audio channels as a function of auditory events. The invention also relates to computer programs for practicing such methods or controlling such apparatus.

### BACKGROUND ART

### Spatial Coding

Certain limited bit rate digital audio coding techniques analyze an input multichannel signal to derive a “downmix” composite signal (a signal containing fewer channels than the input signal) and side-information containing a parametric model of the original sound field. The side-information (“sidechain”) and composite signal, which may be coded, for example, by a lossy and/or lossless bit-rate-reducing encoding, are transmitted to a decoder that applies an appropriate lossy and/or lossless decoding and then applies the parametric model to the decoded composite signal in order to assist in “upmixing” the composite signal to a larger number of channels that recreate an approximation of the original sound field. The primary goal of such “spatial” or “parametric” coding systems is to recreate a multichannel sound field with a very limited amount of data; hence this enforces limitations on the parametric model used to simulate the original sound field. Details of such spatial coding systems are contained in various documents, including those cited below under the heading “Incorporation by Reference.”

Such spatial coding systems typically employ parameters to model the original sound field such as interchannel amplitude or level differences (“ILD”), interchannel time or phase differences (“IPD”), and interchannel cross-correlation (“ICC”). Typically, such parameters are estimated for multiple spectral bands for each channel being coded and are dynamically estimated over time.

In typical prior art N:M:N spatial coding systems in which M=1, a multichannel input signal is converted to the frequency domain using an overlapped DFT (discrete frequency transform). The DFT spectrum is then subdivided into bands approximating the ear's critical bands. An estimate of the interchannel amplitude differences, interchannel time or phase differences, and interchannel correlation is computed for each of the bands. These estimates are utilized to downmix the original input channels into a monophonic or two-channel stereophonic composite signal. The composite signal along with the estimated spatial parameters are sent to a decoder where the composite signal is converted to the frequency domain using the same overlapped DFT and critical band spacing. The spatial parameters are then applied to their corresponding bands to create an approximation of the original multichannel signal.

### Auditory Events and Auditory Event Detection

The division of sounds into units or segments perceived as separate and distinct is sometimes referred to as “auditory event analysis” or “auditory scene analysis” (“ASA”) and the segments are sometimes referred to as “auditory events” or “audio events.” An extensive discussion of auditory scene analysis is set forth by Albert S. Bregman in his book Auditory Scene Analysis—The Perceptual Organization of Sound, Massachusetts Institute of Technology, 1991, Fourth printing, 2001, Second MIT Press paperback edition). In addition, U.S. Pat. No. 6,002,776 to Bhadkamkar, et al, Dec. 14, 1999 cites publications dating back to 1976 as “prior art work related to sound separation by auditory scene analysis.” However, the Bhadkamkar, et al patent discourages the practical use of auditory scene analysis, concluding that “[t]echniques involving auditory scene analysis, although interesting from a scientific point of view as models of human auditory processing, are currently far too computationally demanding and specialized to be considered practical techniques for sound separation until fundamental progress is made.”

A useful way to identify auditory events is set forth by Crockett and Crockett et al in various patent applications and papers listed below under the heading “Incorporation by Reference.” According to those documents, an audio signal (or channel in a multichannel signal) is divided into auditory events, each of which tends to be perceived as separate and distinct, by detecting changes in spectral composition (amplitude as a function of frequency) with respect to time. This may be done, for example, by calculating the spectral content of successive time blocks of the audio signal, calculating the difference in spectral content between successive time blocks of the audio signal, and identifying an auditory event boundary as the boundary between successive time blocks when the difference in the spectral content between such successive time blocks exceeds a threshold. Alternatively, changes in amplitude with respect to time may be calculated instead of or in addition to changes in spectral composition with respect to time.

In its least computationally demanding implementation, the process divides audio into time segments by analyzing the entire frequency band (full bandwidth audio) or substantially the entire frequency band (in practical implementations, band limiting filtering at the ends of the spectrum is often employed) and giving the greatest weight to the loudest audio signal components. This approach takes advantage of a psychoacoustic phenomenon in which at smaller time scales (20 milliseconds (ms) and less) the ear may lend to focus on a single auditory event at a given time. This implies that while multiple events may be occurring at the same time, one component tends to be perceptually most prominent and may be processed individually as though it were the only event taking place. Taking advantage of this effect also allows the auditory event detection to scale with the complexity of the audio being processed. For example, if the input audio signal being processed is a solo instrument, the audio events that are identified will likely be the individual notes being played. Similarly for an input voice signal, the individual components of speech, the vowels and consonants for example, will likely be identified as individual audio elements. As the complexity of the audio increases, such as music with a drumbeat or multiple instruments and voice, the auditory event detection identifies the “most prominent” (i.e., the loudest) audio element at any given moment.

At the expense of greater computational complexity, the process may also take into consideration changes in spectral composition with respect to time in discrete frequency subbands (fixed or dynamically determined or both fixed and dynamically determined subbands) rather than the full bandwidth. This alternative approach takes into account more than one audio stream in different frequency subbands rather than assuming that only a single stream is perceptible at a particular time.

Auditory event detection may be implemented by dividing a time domain audio waveform into time intervals or blocks and then converting the data in each block to the frequency domain, using either a filter bank or a tune-frequency transformation, such as the FFT. The amplitude of the spectral content of each block may be normalized in order to eliminate or reduce the effect of amplitude changes. Each resulting frequency domain representation provides an indication of the spectral content of the audio in the particular block. The spectral content of successive blocks is compared and changes greater than a threshold may be taken to indicate the temporal start or temporal end of an auditory event.

Preferably, the frequency domain data is normalized, as is described below. The degree to which the frequency domain data needs to be normalized gives an indication of amplitude. Hence, if a change in this degree exceeds a predetermined threshold, that too may be taken to indicate an event boundary. Event start and end points resulting from spectral changes and from amplitude changes may be ORed together so that event boundaries resulting from either type of change are identified.

Although techniques described in said Crockett and Crockett at al applications and papers are particularly useful in connection with aspects of the present invention, other techniques for identifying auditory events and event boundaries may be employed in aspects of the present invention.

### DISCLOSURE OF THE INVENTION

According to one aspect of the present invention, an audio encoder receives a plurality of input audio channels and generates one or more audio output channels and one or more parameters describing desired spatial relationships among a plurality of audio channels that may be derived from the one or more audio output channels. Changes in signal characteristics with respect to time in one or more of the plurality of audio input channels are detected and changes in signal characteristics with respect to time in the one or more of the plurality of audio input channels are identified as auditory event boundaries, such that an audio segment between consecutive boundaries constitutes an auditory event in the channel or channels. Some of said one or more parameters are generated at least partly in response to auditory events and/or the degree of change in signal characteristics associated with said auditory event boundaries. Typically, an auditory event is a segment of audio that tends to be perceived as separate and distinct. One usable measure of signal characteristics includes a measure of the spectral content of the audio, for example, as described in the cited Crockett and Crockett et al documents. All or some of the one or more parameters may be generated at least partly in response to the presence or absence of one or more auditory events. An auditory event boundary may be identified as a change in signal characteristics with respect to time that exceeds a threshold. Alternatively, all or some of the one or more parameters may be generated at least partly in response to a continuing measure of the degree of change in signal characteristics associated with said auditory event boundaries. Although, in principle, aspects of the invention may be implemented hi analog and/or digital domains, practical implementations are likely to be implemented in the digital domain in which each of the audio signals are represented by samples within blocks of data. In that case, the signal characteristics may be the spectral content of audio within a block, the detection of changes in signal characteristics with respect to time may be the detection of changes in spectral content of audio from block to block, and auditory event temporal start and stop boundaries each coincide with a boundary of a block of data.

According to another aspect of the invention, an audio processor receives a plurality of input channels and generates a number of audio output channels larger than the number of input channels, by detecting changes in signal characteristics with respect to time in one or more of the plurality of audio input channels, identifying as auditory event boundaries changes in signal characteristics with respect to time in said one or more of the plurality of audio input channels, wherein an audio segment between consecutive boundaries constitutes an auditory event in the channel or channels, and generating said audio output channels at least partly in response to auditory events and/or the degree of change in signal characteristics associated with said auditory event boundaries. Typically, an auditory event is a segment of audio that tends to be perceived as separate and distinct. One usable measure of signal characteristics includes a measure of the spectral content of the audio, for example, as described in the cited Crockett and Crockett et al documents. All or some of the one or more parameters may be generated at least partly in response to the presence or absence of one or more auditory events. An auditory event boundary may be identified as a change in signal characteristics with respect to time that exceeds a threshold. Alternatively, all or some of the one or more parameters may be generated at least partly in response to a continuing measure of the degree of change in signal characteristics associated with said auditory event boundaries. Although, in principle, aspects of the invention may be implemented in analog and/or digital domains, practical implementations are likely to be implemented in the digital domain in which each of the audio signals are represented by samples within blocks of data. In that case, the signal characteristics may be the spectral content of audio within a block, the detection of changes in signal characteristics with respect to time may be the detection of changes in spectral content of audio from block to block, and auditory event temporal start and stop boundaries each coincide with a boundary of a block of data.

Certain aspects of the present invention are described herein in a spatial coding environment that includes aspects of other inventions. Such other inventions are described in various pending United Slates and International Patent Applications of Dolby Laboratories Licensing Corporation, the owner of the present application, which applications are identified herein.

### DESCRIPTION OF THE DRAWINGS

FIG. 1 is a functional block diagram showing an example of an encoder in a spatial coding system in which the encoder receives an N-channel signal that is desired to be reproduced by a decoder in the spatial coding system.

FIG. 2 is a functional block diagram showing an example of an encoder in a spatial coding system in winch the encoder receives an N-channel signal that is desired to be reproduced by a decoder in the spatial coding system and it also receives the M-channel composite signal that is sent from the encoder to a decoder.

FIG. 3 is a functional block diagram showing an example of an encoder in a spatial coding system in which the spatial encoder is part of a blind upmixing arrangement.

FIG. 4 is a functional block diagram showing an example of a decoder in a spatial coding system that is usable with the encoders of any one of FIGS. 1-3.

FIG. 5 is a functional block diagram of a single-ended blind upmixing arrangement.

FIG. 6 shows an example of useful STDFT analysis and synthesis windows for a spatial encoding system embodying aspects of the present invention.

FIG. 7 is a set of plots of the time-domain amplitude versus time (sample numbers) of signals, the first two plots showing a hypothetical two-channel signal within a DFT processing block. The third plot shows the effect of downmixing the two channel signal to a single channel composite and the fourth plot shows the upmixed signal for the second channel using SWF processing.

### BEST MODE FOR CARRYING OUT THE INVENTION

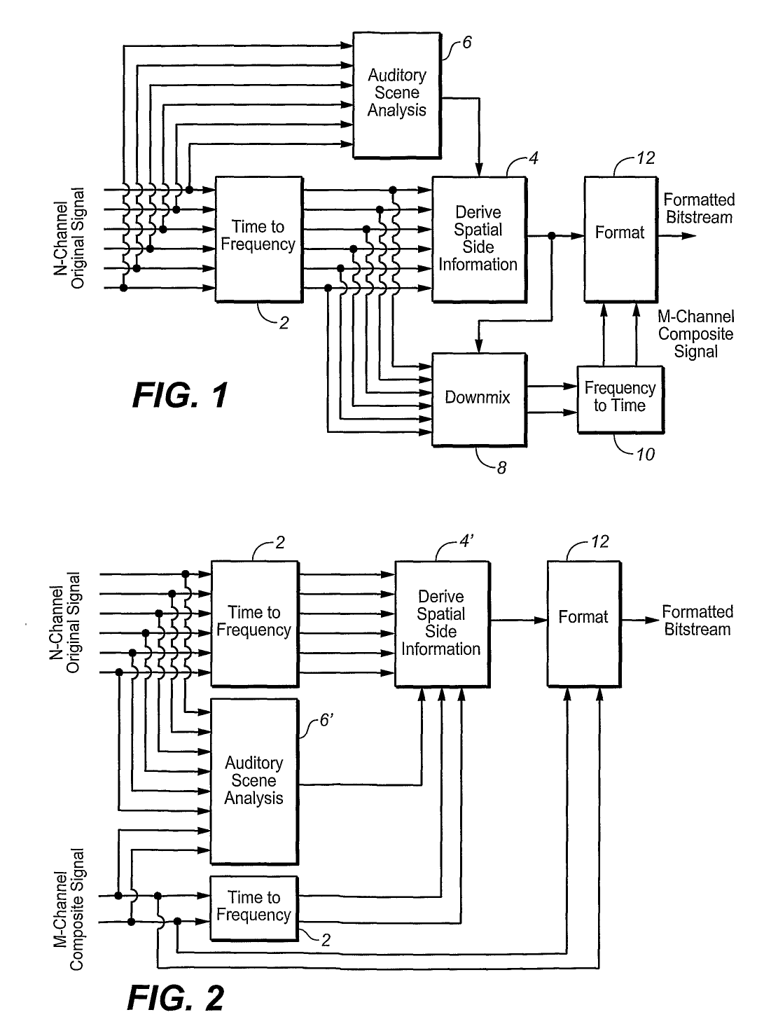

Some examples of spatial encoders in which aspects of the invention may be employed are shown in FIGS. 1, 2 and 3. Generally, a spatial coder operates by taking N original audio signals or channels and mixing them down into a composite signal containing M signals or channels, where M<N. Typically N=6 (5.1 audio), and M=1 or 2. At the same time, a low data rate sidechain signal describing the perceptually salient spatial cues between or among the various channels is extracted from the original multichannel signal. The composite signal may then be coded with an existing audio coder, such as an MPEG-2/4 AAC encoder, and packaged with the spatial sidechain information. At the decoder the composite signal is decoded, and the unpackaged sidechain information is used to upmix the composite into an approximation of the original multichannel signal. Alternatively, the decoder may ignore the sidechain information and simply output the composite signal.

The spatial coding systems proposed in various recent technical papers (such as those cited below) and within the MPEG standards committee typically employ parameters to model the original sound field such as interchannel level differences (ILD), interchannel phase differences (IPD), and interchannel cross-con-elation (ICC). Usually, such parameters are estimated for multiple spectral bands for each channel being coded and are dynamically estimated over time. Aspects of the present invention include new techniques for computing one or more of such parameters. For the sake of describing a useful environment for aspects of the present invention, the present document includes a description of ways to decorrelate the upmixed signal, including decorrelation filters and a technique for preserving the fine temporal structure of the original multichannel signal. Another useful environment for aspects of the present invention described herein is in a spatial encoder that operates in conjunction with a suitable decoder to perform a “blind” upmixing (an upmixing that operates only in response to the audio signal(s) without any assisting control signals) to convert audio material directly from two-channel content to material that is compatible with spatial decoding systems. Certain aspects of such a useful environment are the subject of other United States and International Patent Applications of Dolby Laboratories Licensing Corporation and are identified herein.

### Coder Overview

Some examples of spatial encoders in which aspects of the invention may be employed are shown in FIGS. 1, 2 and 3. In the encoder example of FIG. 1, an N-Channel Original Signal (e.g., digital audio in the PCM format) is converted by a device or function (“Time to Frequency”) 2 to the frequency domain utilizing an appropriate time-to-frequency transformation, such as the well-known Short-time Discrete Fourier Transform (STDFT). Typically, the transform is manipulated such that one or more frequency bins are grouped into bands approximating the ear's critical bands). Estimates of the interchannel amplitude or level differences (“ILD”) interchannel time or phase differences (“IPD”), and interchannel correlation (“ICC”), often referred to as “spatial parameters,” are computed for each of the bands by a device of function (“Derive Spatial Side Information) 4. As will be described in greater detail below, an auditory scene analyzer or analysis function (“Auditory Scene Analysis”) 6 also receives the N-Channel Original Signal and affects the generation of spatial parameters by device or function 4, as described elsewhere in this specification. The Auditory Scene Analysis 6 may employ any combination of channels in the N-Channel Original Signal. Although shown separately to facilitate explanation, the devices or functions 4 and 6 may be a single device or function. If the M-Channel Composite Signal corresponding to the N-Channel Original Signal does not already exist (M<N), the spatial parameters may be utilized to downmix, in a downmixer or downmixing function (“Downmix”) 8, the N-Channel Original Signal into an M-Channel Composite Signal. The M-Channel Composite Signal may then be converted back to the time domain by a device or function (“Frequency to Time”) 10 utilizing an appropriate frequency-to-time transform that is the inverse of device or function 2. The spatial parameters from device or function 4 and the M-Channel Composite Signal in the time domain may then be formatted into a suitable form, a serial or parallel bitstream, for example, in a device or function (“Format”) 12, which may include lossy and/or lossless bit-reduction encoding. The form of the output from Format 12 is not critical to the invention.

Throughout this document, the same reference numerals are used for devices and functions that may be the same structurally or that may perform the same functions. When a device or function is similar in structure of function, but may, for example, differ slightly such as by having additional inputs, the changed but similar device or function is designated with a prime mark (e.g., “4′”). It will also be understood that the various block diagrams are functional block diagrams in which the functions or devices embodying the functions are shown separately even though practical embodiments may combine various ones or all of the functions in a single function or device. For example, the practical embodiment of an encoder, such as the example of FIG. 1, may be implemented by a digital signal processor operating in accordance with a computer program in which portions of the computer program implement various functions. See also below under the heading “Implementation.”

Alternatively, as shown in FIG. 2, if both the N-Channel Original Signal and related M-Channel Composite Signal (each being multiple channels of PCM digital audio, for example) are available as inputs to an encoder, they may be simultaneously processed with the same time-to-frequency transform 2 (shown as two blocks for clarity in presentation), and the spatial parameters of the N-Channel Original Signal may be computed with respect to those of the M-Channel Composite Signal by a device or function (Derive Spatial Side Information) 4′, which may be similar to device or function 4 of FIG. 1, but which receives two sets of input signals. If the set of N-Channel Original Signal is not available, an available M-Channel Composite Signal may be upmixed in the time domain (not shown) to produce the “N-Channel Original Signal”—each multichannel signal respectively providing a set of inputs to the Tune to Frequency devices or functions 2 in the example of FIG. 1. In both the FIG. 1 encoder and the alternative of FIG. 2, the M-Channel Composite Signal and the spatial parameters are then encoded by a device or function (“Format”) 12 into a suitable form, as in the FIG. 1 example. As in the FIG. 1 encoder example, the form of the output from Format 12 is not critical to the invention. As will be described in greater detail below, an auditory scene analyzer or analysis function (“Auditory Scene Analysis”) 6′ receives the N-Channel Original Signal and the M-Channel Composite Signal and affects the generation of spatial parameters by device or function 4′, as described elsewhere in this specification. Although shown separately to facilitate explanation, the devices or functions 4′ and 6′ may be a single device or function. The Auditory Scene Analysis 6′ may employ any combination of the N-Channel Original Signal and the M-Channel Composite Signal.

A further example of an encoder hi which aspects of the present invention may be employed is what may be characterized as a spatial coding encoder for use, with a suitable decoder, in performing “blind” upmixing. Such an encoder is disclosed in the copending International Application PCT/US2006/020882 of Seefeldt, et al, filed May 26, 2006, entitled “Channel Reconfiguration with Side Information,” which application is hereby incorporated by reference in its entirety. The spatial coding encoders of FIGS. 1 and 2 herein employ an existing N-channel spatial image in generating spatial coding parameters. In many cases, however, audio content providers for applications of spatial coding have abundant stereo content but a lack of original multichannel content. One way to address tins problem is to transform existing two-channel stereo content into multichannel (e.g., 5.1 channels) content through the use of a blind upmixing system before spatial coding. As mentioned above, a blind upmixing system uses information available only in the original two-channel stereo signal itself to synthesize a multichannel signal. Many such upmixing systems are available commercially, for example Dolby Pro Logic II (“Dolby”, “Pro Logic” and “Pro Logic II” are trademarks of Dolby Laboratories Licensing Corporation). When combined with a spatial coding encoder, the composite signal could be generated at the encoder by downmixing the blind upmixed signal, as in the FIG. 1 encoder example herein, or the existing two-channel stereo signal could be utilized, as in FIG. 2 encoder example herein.

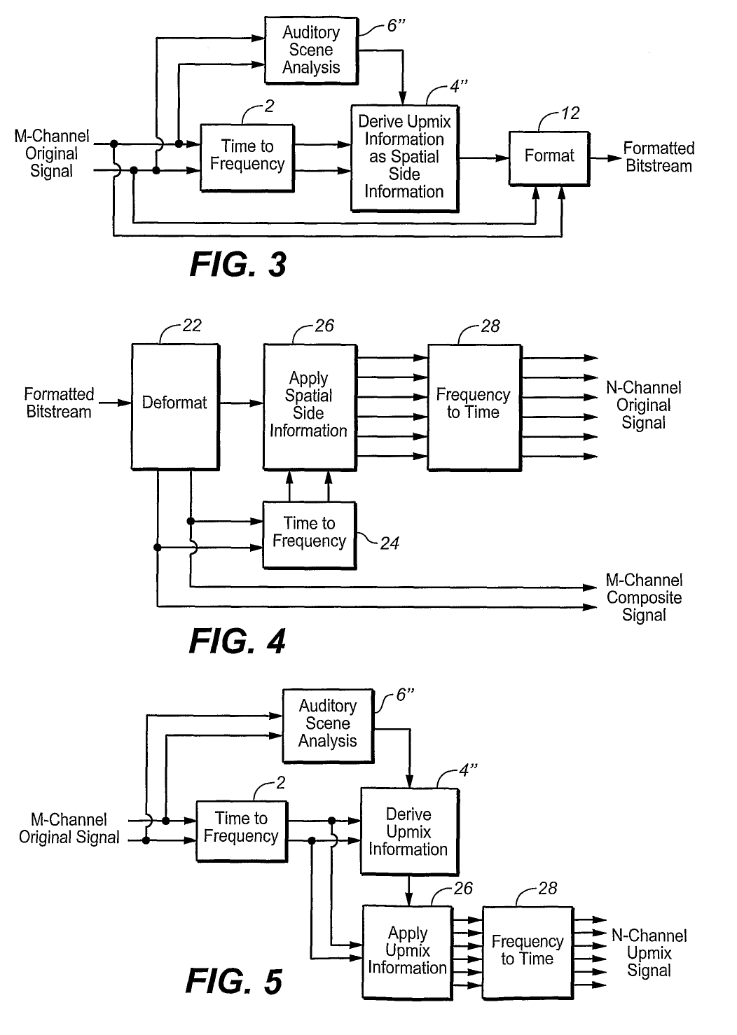

As an alternative, a spatial encoder, as shown in the example of FIG. 3, may be employed as a portion of a blind upmixer. Such an encoder makes use of the existing spatial coding parameters to synthesize a parametric model of a desired multichannel spatial image directly from a two-channel stereo signal without the need to generate an intermediate upmixed signal. The resulting encoded signal is compatible with existing spatial decoders (the decoder may utilize the side information to produce the desired blind upmix, or the side information may be ignored providing the listener with the original two-channel stereo signal).

In the encoder example of FIG. 3, an M-Channel Original Signal (e.g., multiple channels of digital audio in the PCM format) is converted by a device or function (“Time to Frequency”) 2 to the frequency domain utilizing an appropriate time-to-frequency transformation, such as the well-known Short-time Discrete Fourier Transform (STDFT) as in the other encoder examples, such that one or more frequency bins are grouped into bands approximating the ear's critical bands. Spatial parameters are computed for each of the bands by a device of function (“Derive Upmix Information as Spatial Side Information) 4”. As will be described in greater detail below, an auditory scene analyzer or analysis function (“Auditory Scene Analysis”) 6″ also receives the M-Channel Original Signal and affects the generation of spatial parameters by device or function 4″, as described elsewhere in this specification. Although shown separately to facilitate explanation, the devices or functions 4″ and 6″ may be a single device or function. The spatial parameters from device or function 4″ and the M-Channel Composite Signal (still in the time domain) may then be formatted into a suitable form, a serial or parallel bitstream, for example, in a device or function (“Format”) 12, which may include lossy and/or lossless bit-reduction encoding. As in the FIG. 1 and FIG. 2 encoder examples, the form of the output from Format 12 is not critical to the invention. Further details of the FIG. 3 encoder are set forth below under the heading “Blind Upmixing.”

A spatial decoder, shown in FIG. 4, receives the composite signal and the spatial parameters from an encoder such as the encoder of FIG. 1, FIG. 2 or FIG. 3. The bitstream is decoded by a device or function (“Deformat”) 22 to generate the M-Channel Composite Signal along with the spatial parameter side information. The composite signal is transformed to the frequency domain by a device or function (“Time to Frequency”) 24 where the decoded spatial parameters are applied to their corresponding bands by a device or function (“Apply Spatial Side Information”) 26 to generate an N-Channel Original Signal in the frequency domain. Such a generation of a larger number of channels from a smaller number is an upmixing (Device or function 26 may also be characterized as an “Upmixer”). Finally, a frequency-to-time transformation (“Frequency to Time”) 28 (the inverse of the Time to Frequency device or function 2 of FIGS. 1, 2 and 3) is applied to produce approximations of the N-Channel Original Signal (if the encoder is of the type shown in the examples of FIG. 1 and FIG. 2) or an approximation of an upmix of the M-Channel Original Signal of FIG. 3.

Other aspects of the present invention relate to a “stand-alone” or “single-ended” processor that performs upmixing as a function of audio scene analysis. Such aspects of the invention are described below with respect to the description of the FIG. 5 example.

In providing further details of aspects of the invention and environments thereof, throughout the remainder of this document, the following notation is used:
x is the original N channel signal; y is the M channel composite signal (M=1 or 2); z is the N channel signal upmixed from y using only the ILD and IPD parameters; \hat{x} is the final estimate of original signal x after applying decorrelation to z; xᵢ, yᵢ, zᵢ, and \hat{x}ᵢ are channel i of signals x, y, z, and \hat{x}; Xᵢ[k,t], Yᵢ[k,t], Zᵢ[k,t], and \hat{X}ᵢ[k,t] are the STDFTs of the channels xᵢ, yᵢ, zᵢ, and \hat{x}ᵢ at bin k and time-block t.

Active downmixing to generate the composite signal y is performed in the

frequency domain on a per-band basis according to the equation:

$$\begin{matrix}{Y}_{i} [ k , t ] = {\sum }_{j = 1}^{N} {D}_{ij} [ b , t ] {X}_{j} [ k , t ] , & {kb}_{b}\end{matrix} \leq k < k {e}_{b} \qquad ( 1 )$$

where kb_{b} is the lower bin index of band b, ke_{b} is the upper bin index of band b, and D_{y}[b,t] is the complex downmix coefficient for channel i of the composite signal with respect to channel j of the original multichannel signal.

The upmixed signal z is computed similarly in the frequency domain from the composite y:

$${Z}_{i} [ k , t ] = {\sum }_{j = 1}^{M} {U}_{ij} [ b , t ] {Y}_{j} [ k , t ] , \\ {kb}_{b} \leq k < {ke}_{b} \qquad ( 2 )$$

where Uᵢⱼ[b,t] is the upmix coefficient for the channel i of the upmix signal with respect to channel j of the composite signal. The ILD and IPD parameters are given by the magnitude and phase of the upmix coefficient:

ILDᵢⱼ[b,t]=|Uᵢⱼ[b,t]| (3a)

IPDᵢⱼ[b,t]=∠Uᵢⱼ[b,t] (3b)

The final signal estimate \hat{x}̂ is derived by applying decorrelation to the upmixed signal z. The particular decorrelation technique employed is not critical to the present invention. One technique is described in International Patent Publication WO 03/090206 A1, of Breebaart, entitled “Signal Synthesizing,” published Oct. 30, 2003. Instead, one of two other techniques may be chosen based on characteristics of the original signal x. The first technique utilizes a measure of ICC to modulate the degree of decorrelation is described in International Patent Publication WO 2006/026452 of Seefeldt et al, published Mar. 9, 2006, entitled “Multichannel Decorrelation in Spatial Audio Coding.” The second technique, described in International Patent Publication WO 2006/026161 of Vinton, et al, published Mar. 9, 2006, entitled “Temporal Envelope Shaping for Spatial Audio Coding Using Frequency Domain Wiener Filtering,” applies a Spectral Wiener Filter to Zᵢ[k,t] in order to restore the original temporal envelope of each channel of x in the estimate \hat{x}.

### Coder Parameters

Here are some details regarding the computation and application of the ILD, IPD, ICC, and “SWF” spatial parameters. If the decorrelation technique of the above-cited patent application of Vinton et al is employed, then the spatial encoder should also generate an appropriate “SWF” (“spatial wiener filter”) parameter. Common among the first three parameters is their dependence on a time varying estimate of the covariance matrix in each band of the original multichannel signal x. The NxN covariance matrix R[b,t] is estimated as the dot product (a “dot product” is also known as the scalar product, a binary operation that takes two vectors and returns a scalar quantity) between the spectral coefficients in each band across each of the channels of x. In order to stabilize this estimate across time, it is smoothed using a simple leaky integrator (low-pass filter) as shown below:

$${R}_{ij} [ b , t ] = λ {R}_{ij} [ b , t - 1 ] + \frac{1 - λ}{{ke}_{b} - {kb}_{b}} {\sum }_{k = {kb}_{b}}^{k = {ke}_{b} - 1} {X}_{i} [ k , t ] {X}_{j}^{*} [ k , t ] , \qquad ( 4 )$$

Here Rᵢⱼ[b,t] is the element in the i^{th} row and j^{th} column of R[b,t], representing the covariance between the i^{th} and j^{th} channels of x in band b at time-block t, and λ is the smoothing time constant.

### ILD and IPD

Consider the computation of ILD and IPD parameters in the context of generating an active downmix y of the original signal x, and then upmixing the downmix y into an estimate z of the original signal x. In the following discussion, it is assumed that the parameters are computed for subband b and time-block t; for clarity of exposition, the band and time indices are not shown explicitly. In addition, a vector representation of the downmix/upmix process is employed. First consider the case for which the number of channels in the composite signal is M=1, then the case of M=2.

### M=1 System

Representing the original N-channel signal in subband b as the Nx1 complex random vector x, an estimate z of this original vector is computed through the process of downmixing and upmixing as follows:

z=ud^{T}x, (5)

where d is an Nx1 complex downmixing vector and u is an Nx1 complex upmixing vector. It can be shown that the vectors d and u which minimize the mean

square error between z and x are given by:

u*=d=vₘₐₓ, (6)

where vₘₐₓ is the eigenvector corresponding to the largest eigenvalue of R, the covariance matrix of x. Although optimal in a least squares sense, this solution may introduce unacceptable perceptual artifacts. In particular, the solution tends to “zero out” lower level channels of the original signal as it minimizes the error. With the goal of generating both a perceptually satisfying downmixed and upmixed signal, a better solution is one in which the downmixed signal contains some fixed amount of each original signal channel and where the power of each upmixed channel is made equal to that of the original. Additionally, however, it was found that utilizing the phase of the least squares solution is useful in rotating the individual channels prior to downmixing in order to minimize any cancellation between the channels. Likewise, application of the least-squares phase at upmix serves to restore the original phase relation between the channels. The downmixing vector of this preferred solution may be represented as:

d=α d̅.e^{j∠v}^{ₘₐₓ} . (7)

Here d̅ is a fixed downmixing vector which may contain, for example, standard ITU downmixing coefficients. The vector ∠vₘₐₓ is equal to the phase of the complex eigenvector vₘₐₓ, and the operator a×b represents element-by-element multiplication of two vectors. The scalar a is a normalization term computed so that the power of the downmixed signal is equal to the sum of the powers of the original signal channels weighted by the fixed downmixing vector, and can be computed as follows:

$$α = \sqrt{\frac{{\sum }_{i = 1}^{N} {\overline{d}}_{i}^{2} {R}_{ii}}{( \overline{d} \cdot {e}^{j∠ {v}_{max}} ) {R ( \overline{d} \cdot {e}^{j∠ {v}_{max}} )}^{H}}} , \qquad ( 8 )$$

where d̅ᵢ represents the i^{th} element of vector d̅, and Rᵢⱼ represents the element in the i^{th} row and jth column of the covariance matrix R. Using the eigenvector vₘₐₓ presents a problem in that it is unique only up to a complex scalar multiplier. In order to make the eigenvector unique, one imposes the constraint that the element corresponding to the most dominant channel g have zero phase, where the dominant channel is defined as the channel with the greatest energy:

g=arg max(Rᵢᵢ[b,t]). (9)

The upmixing vector u may be expressed similarly to d:

u=β×ū×e^{-j∠v}^{ₘₐₓ}. (10)

Each element of the fixed upmixing vector ū is chosen such that

ūᵢ d̅ᵢ=1, (11)

and each element of the normalization vector β is computed so that the power in each channel of the upmixed signal is equal to the power of the corresponding channel in the original signal:

$${β}_{i} = \sqrt{\frac{{\overline{d}}_{i}^{2} {R}_{ii}}{{\sum }_{j = 1}^{N} {\overline{d}}_{i}^{2} {R}_{jj}}} . \qquad ( 12 )$$

The ILD and IPD parameters are given by the magnitude and phase of the upmixing vector u:

ILDₙ[b,t]=|uᵢ| (13a)

IPDₙ[b,t]=∠uᵢ (13b)

### M=2 System

A matrix equation analogous to (1) can be written for the case when M=2:

$$z = [ {u}_{L} {u}_{R} ] [ \begin{matrix}{d}_{L}^{T} \\ {d}_{R}^{T}\end{matrix} ] x , \qquad ( 14 )$$

where the 2-channel downmixed signal corresponds to a stereo pair with left and right channels, and both these channels have a corresponding downmix and upmix vector. These vectors may be expressed similarly to those in the M=1 system:

d_{L}=α_{L} d̅_{L}×e^{J0}^{_{LR}} (15a)

d_{R}=α_{R} d̅_{R}×e^{j0}^{_{LR}} (15b)

u_{L}=β_{L}×ū_{L}×e^{J0}^{_{LR}} (15c)

u_{R}=β_{R}×ū_{R}×e^{J0}^{_{LR}} (15d)

For a 5.1 channel original signal, the fixed downmix vectors may be set equal to the standard ITU downmix coefficients (a channel ordering of L, C, R, Ls, Rs, LFE is assumed):

$${\overline{d}}_{L} = [ \begin{matrix}1 \\ 1 / \sqrt{2} \\ 0 \\ 1 / \sqrt{2} \\ 0 \\ 1 / \sqrt{2}\end{matrix} ] , \\ {\overline{d}}_{R} = [ \begin{matrix}0 \\ 1 / \sqrt{2} \\ 1 \\ 0 \\ 1 / \sqrt{2} \\ 1 / \sqrt{2}\end{matrix} ] . \qquad ( 16 )$$

With the element-wise constraint that

d̅_{Li}ū_{Li}+ d̅_{Ri}ū_{Ri}=1 (17)

the corresponding fixed upmix vectors are given by

$${\overline{u}}_{L} = [ \begin{matrix}1 \\ 1 / \sqrt{2} \\ 0 \\ \sqrt{2} \\ 0 \\ 1 / \sqrt{2}\end{matrix} ] , \\ {\overline{u}}_{R} = [ \begin{matrix}0 \\ 1 / \sqrt{2} \\ 1 \\ 0 \\ \sqrt{2} \\ 1 / \sqrt{2}\end{matrix} ] . \qquad ( 18 )$$

In order to maintain a semblance of the original signal's image in the two-channel stereo downmixed signal, it was found that the phase of the left and right channels of the original signal should not be rotated and that the other channels, especially the center, should be rotated by the same amount as they are downmixed into both the left and right. This is achieved by computing a common downmix phase rotation as the angle of a weighted sum between elements of the covariance matrix associated with the left channel and elements associated with the right:

θ_{LRi}=∠(d_{Li}d_{Li}Rₗᵢ+d_{Rr}d_{Ri}Rᵣᵢ), (19)

where l and r are the indices of the original signal vector x corresponding to the left and right channels. With the downmix vectors given in (10), the above expression yields θ_{LRi}=θ_{LRr}=0, as desired. Lastly, the normalization parameters in (9a-d) are

computed as in (4) and (7) for the M=1 system. The ILD and IPD parameters are given by:

ILDᵢ₁[b,t]=|u_{Li}| (20a)

ILDᵢ₂[b,t]=|u_{Ri}| (20b)

IPDᵢ₁[b,t]=∠u_{Li} (20c)

IPDᵢ₂[b,t]=∠u_{Ri} (20d)

With the fixed upmix vectors in (12), however, several of these parameters are always zero and need not be explicitly transmitted as side information.

### Decorrelation Techniques

The application of ILD and IPD parameters to the composite signal y restores the inter-channel level and phase relationships of the original signal x in the upmixed signal z. While these relationships represent significant perceptual cues of the original spatial image, the channels of the upmixed signal z remain highly correlated because every one of its channels is derived from the same small number of channels (1 or 2) in the composite y. As a result, the spatial image of z may often sound collapsed in comparison to that of the original signal x. It is therefore desirable to modify the signal z so that the correlation between channels better approximates that of the original signal x. Two techniques for achieving this goal are described. The first technique utilizes a measure of ICC to control the degree of decorrelation applied to each channel of z. The second technique, Spectral Wiener Filtering (SWF), restores the original temporal envelope of each channel of x by filtering the signal z in the frequency domain.

### ICC

A normalized inter-channel correlation matrix C[b,t] of the original signal may be computed from its covariance matrix R[b,t] as follows:

$${C}_{ij} [ b , t ] = \frac{\vert {R}_{ij} [ b , t ] \vert}{\sqrt{{R}_{ii}^{2} [ b , t ] {R}_{jj}^{2} [ b , t ]}} . \qquad ( 21 )$$

The element of C[b,t] at the i^{th} row and j^{th} column measures the normalized correlation between channel i and j of the signal x. Ideally one would like to modify z such that its correlation matrix is equal to C[b,t]. Due to constraints in the sidechain data rate, however, one may instead choose, as an approximation, to modify z such that the correlation between every channel and a reference channel is approximately equal to the corresponding elements in C[b,t]. The reference is selected as the dominant channel g defined in Equation 9. The ICC parameters sent as side information are then set equal to row g of the correlation matrix C[b,t]:

ICCᵢ[b,t]=C_{gl}[b,t]. (22)

At the decoder, the ICC parameters are used to control per band a linear combination of the signal z with a decorrelated signal \tilde{z}:

\hat{X}ᵢ[k,t]=ICCᵢ[b,t]Z[k,t]+\sqrt{1−ICCᵢ²[b,t]}\tilde{Z}ᵢ[k,t]for kb_{b}≦k≦ke_{b} (23)

The decorrelated signal \tilde{z} is generated by filtering each channel of the signal z with a unique LTI decorrelation filter:

\tilde{z}ᵢ=hᵢ*zᵢ. (24)

The filters h, are designed so that all channels of z and \tilde{z} are approximately mutually decorrelated:

E{zᵢ\tilde{z}ⱼ}≅0i=1 . . . N,j=1 . . . N (25)

E{\tilde{z}ᵢ\tilde{z}ⱼ}≅0i=1 . . . N,j=1 . . . N,i≠j

Given (17) and the conditions in (19), along with the stated assumption that the channels of z are highly correlated, it can be shown that the correlation between the dominant channel of the final upmixed signal x and all other channels is given by

Ĉ_{gi}[b,t]≅ICCᵢ([b,t], (26)

which is the desired effect.

In International Patent Publication WO 03/090206 A1, cited elsewhere herein, a decorrelation technique is presented for a parametric stereo coding system in which two-channel stereo is synthesized from a mono composite. As such, only a single decorrelation filter is required. There, the suggested filter is a frequency varying delay in which the delay decreases linearly from some maximum delay to zero as frequency increases. In comparison to a fixed delay, such a filter has the desirable property of providing significant decorrelation without the introduction of perceptible echoes when the filtered signal is added to the unfiltered signal, as specified in (17). In addition, the frequency varying delay introduces notches in the spectrum with a spacing that increases with frequency. This is perceived as more natural sounding than the linearly spaced comb filtering resulting from a fixed delay.

In said WO 03/090206 A 1 document, the only tunable parameter associated with the suggested filter is its length. Aspects of the invention disclosed in the cited International Patent Publication WO 2006/026452 of Seefeldt et al introduce a more flexible frequency varying delay for each of the N required decorrelation filters. The impulse response of each filter is specified as a finite length sinusoidal sequence whose instantaneous frequency decreases monotonically from n to zero over the duration of the sequence:

hᵢ[n]=Gᵢ\sqrt{|ωᵢ^{l}(n)|}cos(φᵢ(n)),n=0 . . . Lₗ

φₗ(t)=∫ωᵢ(t)dt, (27)

where ωᵢ(t) is the monotonically decreasing instantaneous frequency function, ωᵢ^{l}(t) is the first derivative of the instantaneous frequency, φᵢ(t) is the instantaneous phase given by the integral of the instantaneous frequency, and Lᵢ is the length of the filler. The multiplicative term \sqrt{|ωᵢ^{l}(t)|} is required to make the frequency response of hᵢ[n] approximately flat across all frequency, and the gain G₁ is computed such that

$${\sum }_{n = 0}^{{L}_{i}} {h}_{i}^{2} [ n ] = 1. \qquad ( 28 )$$

The specified impulse response has the form of a chirp-like sequence, and as a result, filtering audio signals with such a filter can sometimes result in audible “chirping” artifacts at the locations of transients. This effect may be reduced by adding a noise term to the instantaneous phase of the filter response:

h₁[n]=Gᵢ°\sqrt{|ωᵢ^{l}(n)|}cos(φᵢ(n)+Nᵢ[n]). (29)

Making this noise sequence Nᵢ[n] equal to white Gaussian noise with a variance that is a small fraction of n is enough to make the impulse response sound more noise-like than chirp-like, while the desired relation between frequency and delay specified by ωᵢ(t) is still largely maintained. The filter in (23) has three free parameters: ωᵢ(t), Lᵢ, and Nᵢ[n]. By choosing these parameters sufficiently different from one another across the N filters, the desired decorrelation conditions in (19) can be met.

The decorrelated signal \tilde{z} may be generated through convolution in the time

domain, but a more efficient implementation performs the filtering through multiplication with the transform coefficients of z:

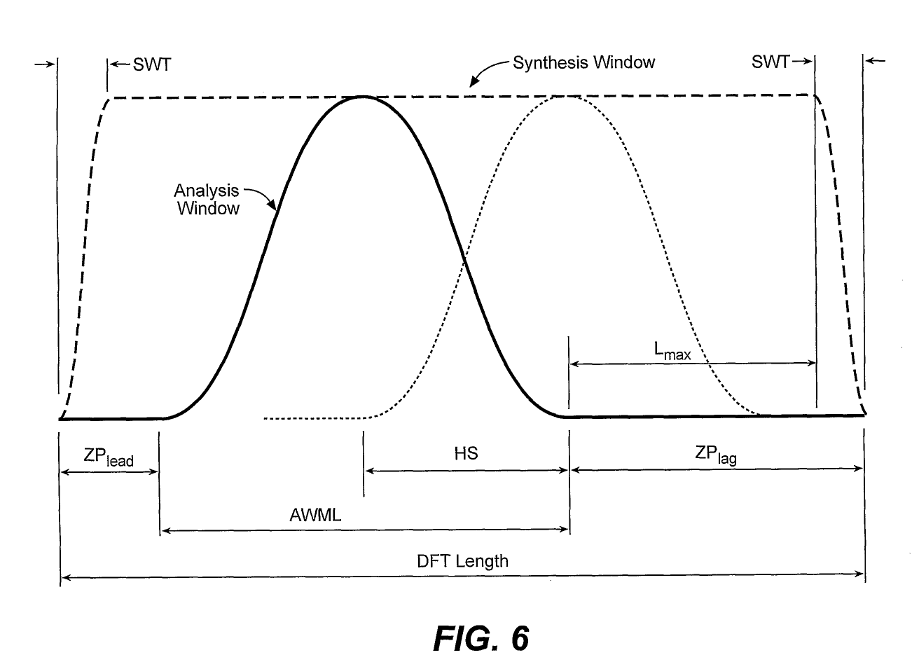

\tilde{Z}ᵢ[k,t]=Hᵢ[k]Zᵢ[k,t], (30)

where Hᵢ[k] is equal to the DFT of hᵢ[n]. Strictly speaking, this multiplication of transform coefficients corresponds to circular convolution in the time domain, but with proper selection of the STDFT analysis and synthesis windows and decorrelation filter lengths, the operation is equivalent to normal convolution. FIG. 6 depicts a suitable analysis/synthesis window pair. The windows are designed with 75% overlap, and the analysis window contains a significant zero-padded region following the main lobe in order to prevent circular aliasing when the decorrelation filters are applied. As long as the length of each decorrelation filter is chosen less than or equal to the length of tins zero padding region, given by Lₘₐₓ in FIG. 6, the multiplication in Equation 30 corresponds to normal convolution in the time domain. In addition to the zero-padding following the analysis window main lobe, a smaller amount of leading zero-padding is also used to handle any non-causal convolutional leakage associated with the variation of ILD, IPD, and ICC parameters across hands.

### Spectral Wiener Filtering

The previous section shows how the inter channel correlation of the original signal x may be restored in the estimate \hat{x} by using the ICC parameter to control the degree of decorrelation on a band-to-band and block-to-block basis. For most signals this works extremely well; however, for some signals, such as applause, restoring the fine temporal structure of the individual channels of the original signal is necessary to re-create the perceived diffuseness of the original sound field. This fine structure is generally destroyed in the downmixing process, and due to the STDFT hop-size and transform length employed, the application of the ILD, IPD, and ICC parameters at times does not sufficiently restore it. The SWF technique, described in the cited International Patent Publication WO 2006/026161 of Vinton et al may advantageously replace the ICC-based technique for these particular problem cases. The new method, denoted Spectral Wiener Filtering (SWF), takes advantage of the time frequency duality: convolution in the frequency domain is equivalent to multiplication in the time domain. Spectral Wiener filtering applies an FIR filter to the spectrum of each of the output channels of the spatial decoder hence modifying the temporal envelope of the output channel to better match the original signal's temporal envelope. This technique is similar to the temporal noise shaping (TNS) algorithm employed in MPEG-2/4 AAC as it modifies the temporal envelope via convolution in the spectral domain. However, the SWF algorithm, unlike TNS, is single ended and is only applied the decoder. Furthermore, the SWF algorithm designs the filter to adjust the temporal envelope of the signal not the coding noise and hence, leads to different filter design constraints. The spatial encoder must design an FIR filter in the spectral domain, which will represent the multiplicative changes in the time domain required to reapply the original temporal envelope in the decoder. This filter problem can be formulated as a least squares problem, which is often referred to as Wiener filter design. However, unlike conventional applications of the Wiener filter, which are designed and applied in the time domain, the filter process proposed here is designed and applied in the spectral domain.

The spectral domain least-squares filter design problem is defined as follows: calculate a set of filter coefficients αᵢ[k,t] which minimize the error between Xᵢ[k,t] and a filtered version of Zᵢ[k,t]:

$${min}_{{a}_{i} [ k , t ]} [ E \{ {X}_{i} [ k , t ] - {\sum }_{m = 0}^{L - 1} {a}_{i} [ m , t ] {Z}_{i} [ k - m , t ] \} ] , \qquad ( 31 )$$

where E is the expectation operator over the spectral bins k, and L is the length of the filter being designed. Note that Xᵢ[k,t] and Zᵢ[k,t] are complex values and thus, hi general, αᵢ[k,t] will also be complex. Equation 31 can be re-expressed using matrix expressions:

min[E{Xₖ-A^{T}Zₖ}], (32)

where

Xₖ=[Xᵢ[k,t]],

Zₖ^{T}=[Zᵢ[k,t] Zᵢ[k−1,t] . . . Zᵢ[k-L+1,t]],

and

A^{T}=[αᵢ[0,t] . . . αᵢ[L−1,t]].

By setting the partial derivatives of (32) with respect to each of the filter coefficients to zero, it is simple to show the solution to the minimization problem is given by:

A=R_{zz}⁻¹R_{ZX}, (33)

where

R_{ZZ}=E{ZₖZₖ^{H}},

R_{ZX}=E{ZₖXₖ^{H}},

At the encoder, the optimal SWF coefficients are computed according to (33) for each channel of the original signal and sent as spatial side information. At the decoder, the coefficients are applied to the upmixed spectrum Z,[k,t] to generate the final estimate

$${\hat{X}}_{i} [ k , t ] = {\sum }_{m = 0}^{L - 1} {a}_{i} [ m , t ] {Z}_{i} [ k - m , t ] , \qquad ( 34 )$$

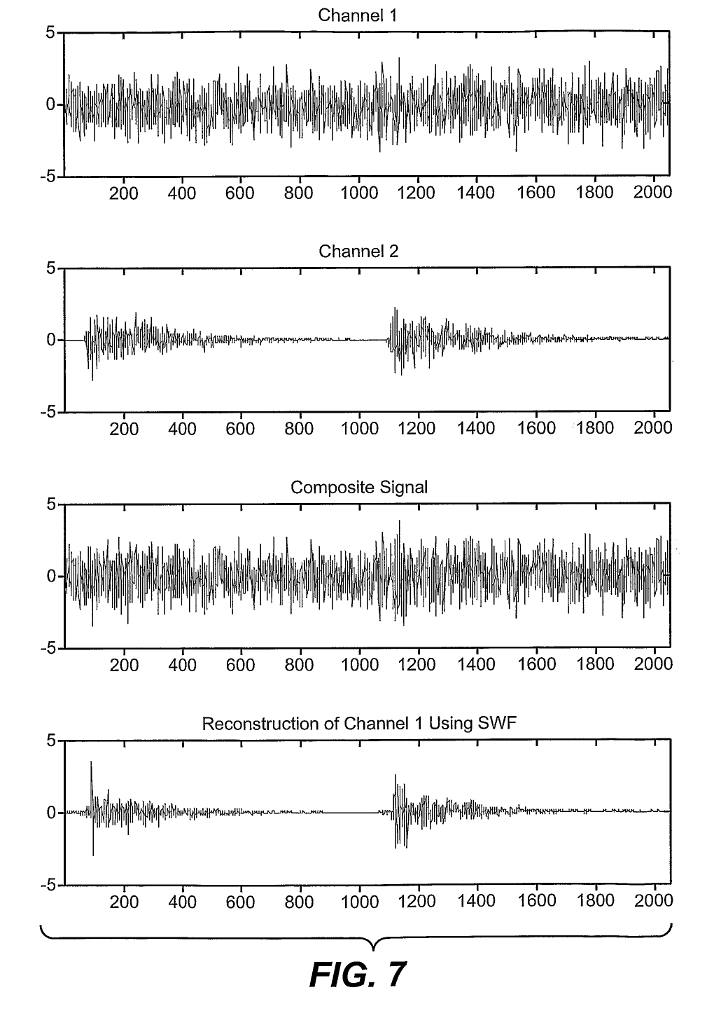

FIG. 7 demonstrates the performance of the SWF processing; the first two plots show a hypothetical two channel signal within a DFT processing block. The result of combining the two channels into a single channel composite is shown in the third plot, where it clear that the downmix process has eradicated the fine temporal structure of the signal in the second most plot. The fourth plot shows the effect of applying the SWF process in the spatial decoder to the second upmix channel. As expected the fine temporal structure of the estimate of the original second channel has been replaced. If the second channel had been upmixed without the use of SWF processing the temporal envelope would have been flat like the composite signal shown in the third plot.

### Blind Upmixing

The spatial encoders of the FIG. 1 and FIG. 2 examples consider estimating a parametric model of an existing TV channel (usually 5.1) signal's spatial image so that an approximation of this image may be synthesized from a related composite signal containing fewer than AT channels. However, as mentioned above, in many cases, content providers have a shortage of original 5.1 content. One way to address this problem is first to transform existing two-channel stereo content into 5.1 through the use of a blind upmixing system before spatial coding. Such a blind upmixing system uses information available only in the original two-channel stereo signal itself to synthesize a 5.1 signal. Many such upmixing systems are available commercially, for example Dolby Pro Logic II. When combined with a spatial coding system, the composite signal could be generated at the encoder by downmixing the blind upmixed signal, as in FIG. 1, or the existing two-channel stereo signal may be utilized, as in FIG. 2.

In an alternative, set forth in the cited pending International Application PCT/US2006/020882 of Seefeldt, et al a spatial encoder is used as a portion of a blind upmixer. This modified encoder makes use of the existing spatial coding parameters to synthesize a parametric model of a desired 5.1 spatial image directly from a two-channel stereo signal without the need to generate an intermediate blind upmixed signal. FIG. 3, described above generally, depicts such a modified encoder.

The resulting encoded signal is then compatible with the existing spatial decoder. The decoder may utilize the side information to produce the desired blind upmix, or the side information may be ignored providing the listener with the original two-channel stereo signal.

The previously-described spatial coding parameters (ILD, IPD, and ICC) may be used to create a 5.1 blind upmix of a two-channel stereo signal in accordance with the following example. This example considers only the synthesis of three surround channels from a left and right stereo pair, but the technique could be extended to synthesize a center channel and an LFE (low frequency effects) channel as well. The technique is based on the idea that portions of the spectrum where the left and right channels of the stereo signal are decorrelated correspond to ambience in the recording and should be steered to the surround channels. Portions of the spectrum where the left and right channels are correlated correspond to direct sound and should remain in the front left and right channels.

As a first step, a 2×2 covariance matrix Q[b,t] for each band of the original two-channel stereo signal y is computed. Each element of this matrix may be updated in the same recursive manner as R[b,t] described earlier:

$${Q}_{ij} [ b , t ] = λ {Q}_{ij} [ b , t - 1 ] + \frac{1 - λ}{{ke}_{b} - {kb}_{b}} {\sum }_{k = {kb}_{b}}^{k = {ke}_{b} - 1} {Y}_{i} [ k , t ] {Y}_{j}^{*} [ k , t ] \qquad ( 35 )$$

Next, the normalized correlation p between the left and right channels is

computed from Q[b,t]:

$$ρ [ b , t ] = \frac{\vert {Q}_{12} [ b , t ] \vert}{\sqrt{{Q}_{11}^{2} [ b , t ] {Q}_{22}^{2} [ b , t ]}} . \qquad ( 36 )$$

Using the ILD parameter, the left and right channels are steered to the left and right surround channels by an amount proportional to ρ. If ρ=0, then the left and rights channels are steered completely to the surrounds. If ρ=1, then the left and right channels

remain completely in the front. In addition, the ICC parameter for the surround channels is set equal to 0 so that these channels receive full decorrelation in order to create a more diffuse spatial image. The full set of spatial parameters used to achieve this 5.1 blind upmix are listed in the table below:

Channel 1 (Left):
ILD₁₁[b,t]=ρ[b,t]
ILD₁₂[b,t]=0
IPD₁₁[b,t]=IPD₁2[b,t]=0
ICC₁[b,t]=1

Channel 2 (Center):
ILD₂₁[b,t]=ILD₂₂[b,t]=IPD₂₁[b,t]=IPD₂₂[b,t]=0
ICC₂[b,t]=1

Channel 3 (Right):
ILD₃₁[b,t]=0
ILD₃₂[b,t]=ρ[b,t]
IPD₃₁[b,t]=IPD₃₂[b,t]=0
ICC3[b,t]=1

Channel 4 (Left surround):
ILD₄₁[b,t]=\sqrt{1−ρ²[b,t]}
ILD₄₂[b,t]=0
IPD₄₁[b,t]=IPD₄₂[b,t]=0
ICC₄[b,t]=0

Channel 5 (Right Surround):
ILD₅ₗ[b,t]=0
ILD₅₂[b,t]=\sqrt{1−ρ²[b,t]}
IPD₅₁[b,t]=IPD₅₂[b,t]=0
ICC₅[b,t]=0

Channel 6 (LFE):
ILD₆₁[b,t]=ILD₆₂[b,t]=IPD₆₁[b,t]=IPD₆₂[b,t]=0
ICC₆[b,t]=1

The simple system described above synthesizes a very compelling surround effect, but more sophisticated blind upmixing tecliniques utilizing the same spatial parameters are possible. The use of a particular upmixing technique is not critical to the invention.

Rather than operate in conjunction with a spatial encoder and decoder, the described blind upmixing system may alternatively operate in a single-ended manner. That is, spatial parameters may be derived and applied at the same time to synthesize an upmixed signal directly from a multichannel stereo signal, such as a two-channel stereo signal. Such a configuration may be useful in consumer devices, such as an audio/video receiver, which may be playing a significant amount of legacy two-channel stereo content, from compact discs, for example. The consumer may wish to transform such content directly into a multichannel signal when played back. FIG. 5 shows an example of a blind upmixer in such a single-ended mode.

In the blind upmixer example of FIG. 5, an M-Channel Original Signal (e.g., multiple channels of digital audio in the PCM format) is converted by a device or function (“Time to Frequency”) 2 to the frequency domain utilizing an appropriate time-to-frequency transformation, such as the well-known Short-time Discrete Fourier Transform (STDFT) as in the encoder examples above, such that one or more frequency bins are grouped into bands approximating the ear's critical bands. Upmix Information in the form of spatial parameters are computed for each of the bands by a device of function (“Derive Upmix Information”) 4″ (which device or function corresponds to the “Derive Upmix Information as Spatial Side Information 4” of FIG. 3. As described above, an auditory scene analyzer or analysis function (“Auditory Scene Analysis”) 6″ also receives the M-Channel Original Signal and affects the generation of upmix information by device or function 4″, as described elsewhere in this specification. Although shown separately to facilitate explanation, the devices or functions 4″ and 6″ may be a single device or function. The upmix information from device or function 4″ are then applied to the corresponding bands of the frequency-domain version of the M-Channel Original Signal by a device or function (“Apply Upmix Information”) 26 to generate an N-Channel Upmix Signal in the frequency domain. Such a generation of a larger number of channels from a smaller number is an upmixing (Device or function 26 may also be characterized as an “Upmixer”). Finally, a frequency-to-time transformation (“Frequency to Time”) 28 (the inverse of the Time to Frequency device or function 2) is applied to produce a N-Channel Upmix Signal, which signal constitutes a blind upmix. Although in the example of FIG. 5 upmix information takes the form of spatial parameters, such upmix information in a stand-alone upmixer device or function generating audio output channels at least partly in response to auditory events and/or the degree of change in signal characteristics associated with said auditory event boundaries need not take the form of spatial parameters.

### Parameter Control with Auditory Events

As shown above, the ILD, IPD, and ICC parameters for both N:M:N spatial coding and blind upmixing are dependent on a time varying estimate of the per-band covariance matrix: R[b,t] in the case of N:M:Nspatial coding and Q[b,t] in the case of two-channel stereo blind upmixing. Care must be taken in selecting the associated smoothing parameter λ from the corresponding Equations 4 and 36 so that the coder parameters vary fast enough to capture the time varying aspects of the desired spatial image, but do not vary so fast as to introduce audible instability in the synthesized spatial image. Particularly problematic is the selection of the dominant reference channel g associated with the IPD in the N:M:N system in which M=1 and the ICC parameter for both the M=1 and M=2 systems. Even if the covariance estimate is significantly smoothed across time blocks, the dominant channel may fluctuate rapidly from block to block if several channels contain similar amounts of energy. This results in rapidly varying IPD and ICC parameters causing audible artifacts in the synthesized signal.

A solution to this problem is to update the dominant channel g only at the boundaries of auditory events. By doing so, the coding parameters remain relatively stable over the duration of each event, and the perceptual integrity of each event is maintained. Changes in the spectral shape of the audio are used to detect auditory event boundaries. In the encoder, at each time block t, an auditory event boundary strength in each channel i is computed as the sum of the absolute difference between the normalized log spectral magnitude of the current block and the previous block:

$$\begin{matrix}{S}_{i} [ t ] = {\sum }_{k} \vert {P}_{i} [ k , t ] - {P}_{i} [ k , t - 1 ] \vert , & ( 37 a ) \\ where \\ {P}_{i} [ k , t ] = log ( \frac{\vert {X}_{i} [ k , t ] \vert}{{max}_{k} \{ \vert {X}_{i} [ k , t ] \vert \}} ) , & ( 37 b )\end{matrix}$$

If the event strength Sᵢ[t] is greater than some fixed threshold T_{S} in any channel i, then the dominant channel g is updated according to Equation 9. Otherwise, the dominant channel holds its value from the previous time block.

The technique just described is an example of a “hard decision” based on auditory events. An event is either detected or it is not, and the decision to update the dominant channel is based on this binary detection. Auditory events may also be used in a “soft decision” manner. For example, the event strength Sᵢ[t] may be used to continuously vary the parameter λ used to smooth either of the covariance matrices R[b,t] or Q[b,t]. If Sᵢ[t] is large, then a strong event has occurred, and the matrices should be updated

with little smoothing in order to quickly capture the new statistics of the audio associated with the strong event. If Sᵢ[t] is small, then audio is within an event and relatively stable; the covariance matrices should therefore be smoothed more heavily. One method for computing X between some minimum (minimal smoothing) and maximum (maximal

smoothing) based on this principal is given by:

$$λ = \{ \begin{matrix}{λ}_{min} , & {S}_{i} [ t ] > {T}_{max} \\ \frac{{S}_{i} [ t ] - {T}_{min}}{{T}_{max} - {T}_{min}} ( {λ}_{min} - {λ}_{max} ) + {λ}_{max} , & {T}_{max} \geq {S}_{i} [ t ] \geq {T}_{min} \\ {λ}_{max} , & {S}_{i} [ t ] < {T}_{min} .\end{matrix} \qquad ( 38 )$$

### Implementation

The invention may be implemented in hardware or software, or a combination of both (e.g., programmable logic arrays). Unless otherwise specified, the algorithms included as part of the invention are not inherently related to any particular computer or other apparatus. In particular, various general-purpose machines may be used with programs written in accordance with the teachings herein, or it may be more convenient to construct more specialized apparatus (e.g., integrated circuits) to perform the required method steps. Thus, the invention may be implemented in one or more computer programs executing on one or more programmable computer systems each comprising at least one processor, at least one data storage system (including volatile and non-volatile memory and/or storage elements), at least one input device or port, and at least one output device or port. Program code is applied to input data to perform the functions described herein and generate output information. The output information is applied to one or more output devices, in known fashion.

Each such program may be implemented in any desired computer language (including machine, assembly, or high level procedural, logical, or object oriented programming languages) to communicate with a computer system. In any case, the language may be a compiled or interpreted language.

Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

A number of embodiments of the invention have been described. Nevertheless, it will be understood that various modifications may be made without departing from the spirit and scope of the invention. For example, some of the steps described herein may be order independent, and thus can be performed in an order different from that described.

### Incorporation by Reference

The following patents, patent applications and publications are hereby incorporated by reference, each in their entirety.

### Spatial and Parametric Coding

Published International Patent Application WO 2005/086139 A1, published Sep. 15, 2005.

Published International Patent Application WO 2006/026452, published Mar. 9, 2006.

International Application PCT/US2006/020882 of Seefeldt et al, filed May 26, 2006, entitled Channel Reconfiguration with Side Information.

United States Published Patent Application US 2003/0026441, published Feb. 6, 2003.

United States Published Patent Application US 2003/0035553, published Feb. 20, 2003.

United States Published Patent Application US 2003/0219130 (Baumgarte & Faller) published Nov. 27, 2003,

Audio Engineering Society Paper 5852, March 2003

Published International Patent Application WO 03/090207, published Oct. 30, 2003

Published International Patent Application WO 03/090208, published Oct. 30, 2003

Published International Patent Application WO 03/007656, published Jan. 22, 2003,

Published International Patent Application WO 03/090206, published Oct. 30, 2003.

United States Published Patent Application Publication US 2003/0236583 A1, Baumgarte et al, published Dec. 25, 2003.

“Binaural Cue Coding Applied to Stereo and Multichannel Audio Compression,” by Faller et al, Audio Engineering Society Convention Paper 5574, 112^{th} Convention, Munich, May 2002.

“Why Binaural Cue Coding is Better than Intensity Stereo Coding,” by Baumgarte et al, Audio Engineering Society Convention Paper 5575, 112^{th} Convention, Munich, May 2002.

“Design and Evaluation of Binaural Cue Coding Schemes,” by Baumgarte et al, Audio Engineering Society Convention Paper 5706, 113^{th} Convention, Los Angeles, October 2002.

“Efficient Representation of Spatial Audio Using Perceptual Parameterization,” by Faller et al, IEEE Workshop on Applications of Signal Processing to Audio and Acoustics 2001, New Paltz, N.Y., October 2001, pp. 199-202.

“Estimation of Auditory Spatial Cues for Binaural Cue Coding,” by Baumgarte et al, Proc. ICASSP 2002, Orlando, Fla., May 2002, pp. 11-1801-1804.

“Binaural Cue Coding: A Novel and Efficient Representation of Spatial Audio,” by Faller et al, Proc. ICASSP 2002, Orlando, Fla., May 2002, pp. II-1841-II-1844.

“High-quality parametric spatial audio coding at low bitrates,” by Breebaart et al, Audio Engineering Society Convention Paper 6072, 116^{th} Convention, Berlin, May 2004.

“Audio Coder Enhancement using Scalable Binaural Cue Coding with Equalized Mixing,” by Baumgarte et al, Audio Engineering Society Convention Paper 6060, 116^{th} Convention, Berlin, May 2004.

“Low complexity parametric stereo coding,” by Schuijers et al, Audio Engineering Society Convention Paper 6073, 116^{th} Convention, Berlin, May 2004.

“Synthetic Ambience in Parametric Stereo Coding,” by Engdegard et al, Audio Engineering Society Convention Paper 6074, 116^{th} Convention, Berlin, May 2004.

### Detecting and Using Auditory Events

United States Published Patent Application US 2004/0122662 A1, published June 24, 2004.

United States Published Patent Application US 2004/0148159 A1, published Jul. 29, 2004.

United States Published Patent Application US 2004/0165730 A1, published Aug. 26, 2004.

United States Published Patent Application US 2004/0172240 A1, published Sep. 2, 2004.

Published International Patent Application WO 2006/019719, published Feb. 23, 2006.

“A Method for Characterizing and Identifying Audio Based on Auditory Scene Analysis,” by Brett Crockett and Michael Smithers, Audio Engineering Society Convention Paper 6416, 118^{th} Convention, Barcelona, May 28-31, 2005.

“High Quality Multichannel Time Scaling and Pitch-Shifting using Auditory Scene Analysis,” by Brett Crockett, Audio Engineering Society Convention Paper 5948, New York, October 2003.

### Decorrelation

International Patent Publication WO 03/090206 A1, of Breebaart, entitled “Signal Synthesizing,” published Oct. 30, 2003.

International Patent Publication WO 2006/026161, published Mar. 9, 2006.

International Patent Publication WO 2006/026452, published Mar. 9, 2006.

### MPEG-2/4 AAC

ISO/IEC JTC1/SC29, “Information technology—very low bitrate audio-visual coding,” ISO/IEC IS-14496 (Part 3, Audio), 1996

1) ISO/IEC 13818-7. “MPEG-2 advanced audio coding, AAC”. International Standard, 1997;

M. Bosi, K. Brandenburg, S. Quackenbush, L. Fielder, K. Akagiri, H. Fuchs, M. Dietz, J. Herre, G. Davidson, and Y. Oikawa: “ISO/IEC MPEG-2 Advanced Audio Coding”. Proc. of the 101st AES-Convention, 1996;

M. Bosi, K. Brandenburg, S. Quackenbush, L. Fielder, K. Akagiri, H. Fuchs, M. Dietz, J. Herre, G. Davidson, Y. Oikawa: “ISO/IEC MPEG-2 Advanced Audio Coding”, Journal of the AES, Vol. 45, No. 10, October 1997, pp. 789-814;

Karlheinz Brandenburg: “MP3 and AAC explained”. Proc. of the AES 17 th International Conference on High Quality Audio Coding, Florence, Italy, 1999; and G. A. Soulodre et al.: “Subjective Evaluation of State-of-the-Art Two-Channel Audio Codecs” J. Audio Eng. Soc., Vol. 46, No. 3, pp 164-177, March 1998.

1. An audio encoding method in which an encoder receives a plurality of input channels and generates one or more audio output channels and one or more parameters describing desired spatial relationships among a plurality of audio channels that may be derived from the one or more audio output channels, comprising
detecting changes in signal characteristics with respect to time in one or more of the plurality of audio input channels,
identifying as auditory event boundaries changes in signal characteristics with respect to time in said one or more of the plurality of audio input channels, wherein an audio segment between consecutive boundaries constitutes an auditory event in the channel or channels, and
generating all or some of said one or more parameters at least partly in response to auditory events and/or the degree of change in signal characteristics associated with said auditory event boundaries.

2. An audio processing method in which a processor receives a plurality of input channels and generates a number of audio output channels larger than the number of input channels, comprising
detecting changes in signal characteristics with respect to time in one or more of the plurality of audio input channels,
identifying as auditory event boundaries changes in signal characteristics with respect to time in said one or more of the plurality of audio input channels, wherein an audio segment between consecutive boundaries constitutes an auditory event in the channel or channels, and
generating said audio output channels at least partly in response to auditory events and/or the degree of change in signal characteristics associated with said auditory event boundaries.

3. A method according to claim 1 or claim 2 wherein an auditory event is a segment of audio that tends to be perceived as separate and distinct.

4. A method according to claim 1 or claim 2 wherein said signal characteristics include the spectral content of the audio.

5. (canceled)

6. A method according to claim 1 or claim 2 wherein said identifying identifies as an auditory event boundary a change in signal characteristics with respect to time that exceeds a threshold.

7. A method according to claim 1 wherein one or more parameters depend at least in part on the identification of the dominant input channel, and, in generating such parameters, the identification of the dominant input channel may change only at an auditory event boundary.

8. A method according to claim 1 wherein all or some of said one or more parameters are generated at least partly in response to a continuing measure of the degree of change in signal characteristics associated with said auditory event boundaries.

9. The method of claim 8 wherein one or more parameters depend at least in part on a time varying estimate of the covariance between one or more pairs of input channels, and, in generating such parameters, the covariance is time-smoothed using a smoothing time constant responsive to changes in the strength of auditory events over time.

10. A method according to claim 1 or claim 2 wherein each of the audio channels are represented by samples within blocks of data.

11. A method according to claim 10 wherein said signal characteristics are the spectral content of audio in a block.

12. A method according to claim 11 wherein the detection of changes in signal characteristics with respect to time is the detection of changes in spectral content of audio from block to block.

13. A method according to claim 12 wherein auditory event temporal start and stop boundaries each coincide with a boundary of a block of data.

14. Apparatus adapted to perform the methods of any one of claim 1 or claim 2.

15. A computer program, stored on a computer-readable medium, for causing a computer to control the apparatus of claim 14.

16. A computer program, stored on a computer-readable medium, for causing a computer to perform the methods of claim 1 or claim 2.

17. (canceled)

18. (canceled)

19. An audio encoder in which the encoder receives a plurality of input channels and generates one or more audio output channels and one or more parameters describing desired spatial relationships among a plurality of audio channels that may be derived from the one or more audio output channels, comprising
means for detecting changes in signal characteristics with respect to time in one or more of the plurality of audio input channels,
means for identifying as auditory event boundaries changes in signal characteristics with respect to time in said one or more of the plurality of audio input channels, wherein an audio segment between consecutive boundaries constitutes an auditory event in the channel or channels, and
means for generating all or some of said one or more parameters at least partly in response to auditory events and/or the degree of change in signal characteristics associated with said auditory event boundaries.

20. An audio encoder in which the encoder receives a plurality of input channels and generates one or more audio output channels and one or more parameters describing desired spatial relationships among a plurality of audio channels that may be derived from the one or more audio output channels, comprising
a detector that detects changes in signal characteristics with respect to time in one or more of the plurality of audio input channels and identifies as auditory event boundaries changes in signal characteristics with respect to time in said one or more of the plurality of audio input channels, wherein an audio segment between consecutive boundaries constitutes an auditory event in the channel or channels, and
a parameter generator that generates all or some of said one or more parameters at least partly in response to auditory events and/or the degree of change in signal characteristics associated with said auditory event boundaries.

21. An audio processor in which the processor receives a plurality of input channels and generates a number of audio output channels larger than the number of input channels, comprising
means for detecting changes in signal characteristics with respect to time in one or more of the plurality of audio input channels,
means for identifying as auditory event boundaries changes in signal characteristics with respect to time in said one or more of the plurality of audio input channels, wherein an audio segment between consecutive boundaries constitutes an auditory event in the channel or channels, and
means for generating said audio output channels at least partly in response to auditory events and/or the degree of change in signal characteristics associated with said auditory event boundaries.

22. An audio processor in which the processor receives a plurality of input channels and generates a number of audio output channels larger than the number of input, comprising
a detector that detects changes in signal characteristics with respect to time in one or more of the plurality of audio input channels and identifies as auditory event boundaries changes in signal characteristics with respect to time in said one or more of the plurality of audio input channels, wherein an audio segment between consecutive boundaries constitutes an auditory event in the channel or channels, and
an upmixer that generates said audio output channels at least partly in response to auditory events and/or the degree of change in signal characteristics associated with said auditory event boundaries.
